(19) United States
(12) Patent Application Publication
(10) Pub. No.: US 2017/0308974 A1
(43) Pub. Date: Oct. 26, 2017

(54) SYSTEMS AND METHODS FOR MANAGING THE ACQUISITION AND MANAGEMENT OF SITES

(71) Applicant: Antarctica Citizens IP, LLC, New York, NY (US)

(72) Inventors: Sadashiv Adiga, Hercules, CA (US); Richard Charles Graham, Powder Springs, GA (US); Calvin Atkinson, Alpharetta, GA (US)

(21) Appl. No.: 15/483,518

(22) Filed: Apr. 10, 2017

Related U.S. Application Data
(60) Provisional application No. 62/326,400, filed on Apr. 22, 2016.

(51) Int. Cl. G06Q 50/16; G06F 17/30

(52) U.S. Cl. CPC G06Q 50/167; G06F 17/30345

(57) ABSTRACT

The management and acquisition of sites (e.g., parking sites) in a manner that provides continuity of data access and storage during the transition of a site from one management entity to another is discussed. Also discussed are methods and systems for ensuring transparency regarding the current status and time to closing for a transaction involving sites.

### TECHNICAL FIELD

The present invention relates to systems and methods for managing the acquisition and management of sites, and in particular to systems and methods for locating parking sites, negotiating the purchase of new parking sites, acquiring new parking sites, and transitioning management of purchased or acquired parking sites to an acquiring entity.

### BACKGROUND

Often times, many entities are involved in closing a transaction to acquire a parking site, and in ultimately operating the parking site. Each entity or individual involved in this process has their own set of data, and in most cases, this data is not coordinated with that of the other entities involved in the transaction and operation of the parking site. For example, reports are prepared by different entities using different information/data sets, and in some cases, different platforms (e.g., emails, Word documents, Notes, Excel spreadsheets, etc.). Accordingly, there is a need for continuity of data access and storage during the transition of a parking site from one entity to another.

Additionally, in conventional parking site management systems there does not appear to be a centralized method or system for determining the current status of a parking site, and determining the time to closing a transaction. Accordingly, there is a need for transparency regarding the current status and time to closing a transaction.

### SUMMARY

Disclosed herein are systems and methods for managing the acquisition and management of sites in a manner that provides continuity of data access and storage during the transition of a parking site from one entity to another (i.e., a transaction) and transparency regarding the current status and time to closing a transaction.

An exemplary embodiment of the disclosed system manages the acquisition and management of sites. The disclosed system includes a database stored on a server, an exchange application associated with an acquisition and management service and installed on one or more user devices accessible to one or more users. Each of the one or more user devices may include a user interface. The server also includes a processing device that may be in communication with the user interfaces. The processing device may be configured to receive data associated with a site from at least one of the one or more user devices, determine whether the database contains a record associated with the received site, create, in the database, a new record for the site when it is determined that the database does not contain the record associated with the site, update, in the database, an existing record for the site when it is determined that the database contains the record associated with the site, and cause the user interface on the one or more user devices to display updated information retrieved from the database.

In another exemplary embodiment, a method manages the acquisition and management of sites. The method may receive, on a processing device, data associated with a site from a user device, determine whether a database contains a record associated with the received site, creating a new record in the database when it is determined that the database does not contain the record associated with the site, update an existing record in the database when it is determined that the database contains the record associated with the site, and displaying, on a user interface, updated information retrieved from the database.

### BRIEF DESCRIPTION OF THE DRAWINGS

FIG. 1 illustrates the network architecture of a computer system according to an exemplary embodiment of the present invention.

FIG. 2 illustrates a flow diagram for a method for managing parking sites according to an exemplary embodiment of the present invention.

FIG. 3 illustrates an exemplary screen shot of a home page for a software program according to an exemplary embodiment of the present invention.

FIG. 4 illustrates an exemplary screen shot of a “Property” Record for a software program according to an exemplary embodiment of the present invention.

FIG. 5 illustrates an exemplary screen shot for editing a “Property” Record for a software program according to an exemplary embodiment of the present invention.

FIG. 6 illustrates another exemplary screen shot for editing a “Property” Record for a software program according to an exemplary embodiment of the present invention.

FIG. 7 illustrates another exemplary screen shot for editing a “Property” Record for a software program according to an exemplary embodiment of the present invention.

FIG. 8 illustrates another exemplary screen shot for editing a “Property” Record for a software program according to an exemplary embodiment of the present invention.

FIG. 9 illustrates an exemplary screen shot of an “Opportunity” Record for a software program according to an exemplary embodiment of the present invention.

FIG. 10 illustrates an exemplary screen shot of a listing of “Opportunity” Records for a software program according to an exemplary embodiment of the present invention.

FIG. 11 illustrates the stages associated with an “Opportunity” Record for a software program according to an exemplary embodiment of the present invention.

FIG. 12 illustrates an exemplary screen shot of history associated with an “Opportunity” Record for a software program according to an exemplary embodiment of the present invention.

FIG. 13 illustrates an exemplary screen shot of an email for a software program according to an exemplary embodiment of the present invention.

FIG. 14 illustrates an exemplary screen shot of a second email for a software program according to an exemplary embodiment of the present invention.

FIG. 15 illustrates an exemplary screen shot for editing a “Location” Record for a software program according to an exemplary embodiment of the present invention.

FIG. 16 illustrates an exemplary screen shot of an email for a software program according to an exemplary embodiment of the present invention.

FIG. 17 illustrates an exemplary screen shot of various windows associated with a “Location” Record for a software program according to an exemplary embodiment of the present invention.

FIG. 18 illustrates an exemplary screen shot for editing a “Claim” for a software program according to an exemplary embodiment of the present invention.

FIG. 19 illustrates an exemplary screen shot of a process for entering a “Claim” in a software program according to an exemplary embodiment of the present invention.

FIG. 20 illustrates a second exemplary screen shot of a process for entering a “Claim” in a software program according to an exemplary embodiment of the present invention.

FIG. 21 illustrates a third exemplary screen shot of a process for entering a “Claim” in a software program according to an exemplary embodiment of the present invention.

FIG. 22 illustrates a fourth exemplary screen shot of a process for entering a “Claim” in a software program according to an exemplary embodiment of the present invention.

FIG. 23 illustrates a fifth exemplary screen shot of a process for entering a “Claim” in a software program according to an exemplary embodiment of the present invention.

FIG. 24 illustrates a sixth exemplary screen shot of a process for entering a “Claim” in a software program according to an exemplary embodiment of the present invention.

FIG. 25 illustrates a seventh exemplary screen shot of a process for entering a “Claim” in a software program according to an exemplary embodiment of the present invention.

FIG. 26 illustrates an eighth exemplary screen shot of a process for entering a “Claim” in a software program according to an exemplary embodiment of the present invention.

FIG. 27 illustrates a ninth exemplary screen shot of a process for entering a “Claim” in a software program according to an exemplary embodiment of the present invention.

FIG. 28 illustrates a tenth exemplary screen shot of a process for entering a “Claim” in a software program according to an exemplary embodiment of the present invention.

FIG. 29 illustrates an exemplary screen shot of a process for viewing a “Claim” in a software program according to an exemplary embodiment of the present invention.

FIG. 30 illustrates a second exemplary screen shot of a process for viewing a “Claim” in a software program according to an exemplary embodiment of the present invention.

### DETAILED DESCRIPTION

While the system and method of the present disclosure are described below as specifically relating to the acquisition of parking sites (i.e., properties and locations), those of ordinary skill in the art will realize that the present invention may be utilized to manage the acquisition of any type of site, in any type of business. For example, the system and method of the present disclosure could be utilized to manage the acquisition of gas stations, supermarkets, restaurants, etc.

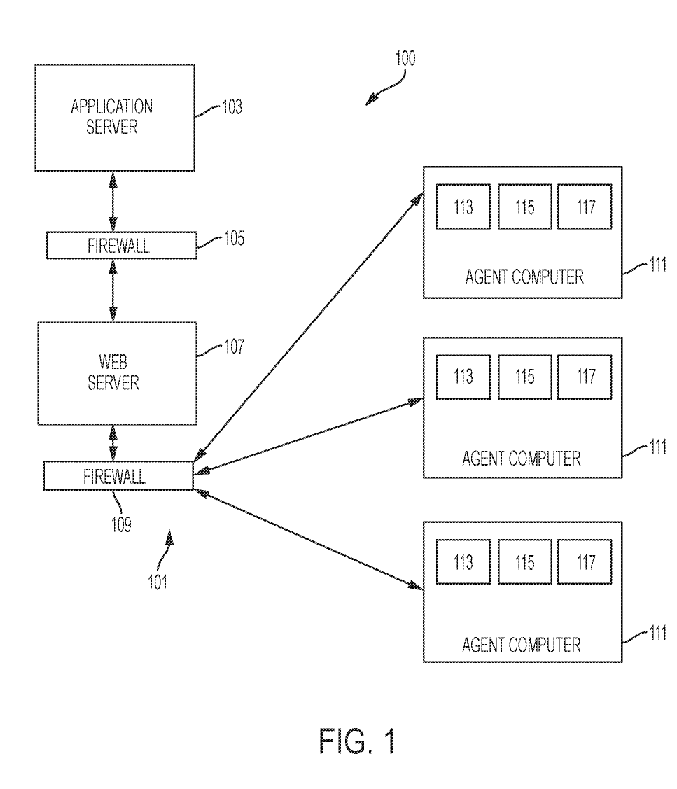

Reference now is made to the drawings. FIG. 1 illustrates the network architecture 100 of a system used in connection with the present disclosure. As depicted, an exchange application 101 associated with an acquisition and management system may include one or more servers including an application server 103 and a web server 107. The application server 103 may be communicatively coupled to a database (not shown). Additionally, the one or more servers may include one or more processing devices that are in communication with the servers and/or user computing systems 111. In one embodiment, a firewall system 109 may be setup between the web server 107 and user computing systems 111. A firewall system 105 may also be setup between the webserver 107 and application server 103. The firewall systems may be used to prevent tampering and corrupting of the web server 107 and application server 103 from external sources. In alternative embodiments, the web server and the application server may be an integrated unit. The database (and other non-transitory memory components) of the exchange application 101 may store computer readable instructions for implementing the methods and systems described herein. The computer readable instructions may be executed by one or more processors of the exchange application 101 in order to implement the methods and systems described herein.

Each of the user computing systems 111 may be coupled to the web server 107 by a communication link 30 such as, for example, the Internet or an Intranet. Each user computing system 111 may be associated with an individual or company participating in the acquisition and/or management of a site. The user computing systems 111 may each include one or more components including, for example, a visual display 113, user interface 115 including input and/or output components such as, for example, keyboards, mice, touchscreens, game controllers, cameras, and/or microphone, and printer 28, and the like. The user computing systems 111 may also include mass storage, memory, display, processor, and location-aware technology (such as geospatial positioning systems GPS). The mass storage may include other application programs or links to other web servers and/or application servers other than those described herein. For example the mass storage may include an email program, calendar program, telephone/messaging program, mobile device tracking program, and a browser. Programs on the mass storage may be executed by the processor using memory and with output being displayed on the visual display 113 to achieve the various functions described herein. For purposes of this and the following description, the term “user computing device” refers to any computing device, including but not limited to tablet computers, smart phones, smart watches, Personal Digital Assistants (PDAs), Personal Computer devices and other similar devices.

The system according to the present invention may be carried out on various mobile devices, such as tablet computers (e.g., Apple iPad, Samsung Galaxy Tab, etc.), smart phones (e.g., Apple iPhone, Blackberry Phone, Android Phone, etc.), smart watch (e.g., Apple Watch, etc.) Personal Digital Assistants (PDAs), Personal Computer devices (PCs; through web browser and installable software) and the like. The mobile devices may be connected over a network such as a Local Area Network (LAN), Wide Area Network (WAN), digital subscriber line (DSL), wireless networks (e.g., 3G or 4G networks), or other equivalent connection means. The mobile devices may communicate over the network using programs or applications (‘App’ or ‘Apps’). In one preferred embodiment, the method of the present disclosure is carried out by an App running on one or more mobile devices.

The term “computing device” as used herein is intended for all purposes to be interpreted broadly and is defined for all uses, all devices, and/or all systems and/or systems in this disclosure as a device comprising at least a central processing unit, a communications device for interfacing with a data network, transitory computer-readable memory, and/or a non-transitory computer-readable memory and/or media. The central processing unit carries out the instructions of one or more computer programs stored in the non-transitory computer-readable memory and/or media by performing arithmetical, logical, and input/output operations to accomplish in whole or in part one or more steps of any method described herein. A computing device is usable by one or more users, other computing devices directly and/or indirectly, actively and/or passively for one or more suitable functions herein. The computing device may be embodied as computer, a laptop, a tablet computer, a smartphone, and/or any other suitable device and may also be a networked computing device, a server, or the like. Where beneficial, a computing device preferably includes one or more human input devices such as a computer mouse and/or keyboard and one or more human interaction device such as one or more monitors. A computing device may refer to any input, output, and/or calculating device associated with providing a virtual reality experience to one or more users. Although one computing device may be shown and/or described, multiple computing devices may be used. Conversely, where multiple computing devices are shown and/or described, a single computing device may be used.

The disclosed systems and methods permit an established parking company to track the acquisition of new parking sites from start to finish. For example, it allows the parking company to keep track of leads for new parking sites, convert those leads into opportunities to acquire new parking sites, and transition those opportunities into additional parking sites for the parking company.

In particular, one or more processing devices of the server may be configured to receive data associated with a site from the user devices. The processing device may then determine whether the database of the application server contains a record that is associated with the site. If the processing device determines that the database does not contain a record associated with the site, it may create a new record for the site. If the processing device determines that the database does contain a record associated with the site, it may use the received data to update the information contained in the existing record for the site. The processing device may also cause a user interface on the user device to update their display when the record associated with the displayed site is updated in the database.

Data may be input by a user of the user device 111. The data may be transmitted via a network to the web server 107 and then routed to the application server 103. The application server may make the evaluation as to whether a database associated with the application server contains a record associated with the site. A record may include an entry into a database that contains information regarding a site. The type of information (i.e., fields) held by a record may depend on the record's class. Possible record classes include “Property”, “Opportunity”, and “Location”. For example, a “Property” record may include information regarding one or more of a property address, and an owner. Similarly, an “Opportunity” record may include information regarding one or more of a stage, a probability, a close date, services needed, and a current operator. Additionally, a “Location” record may include information regarding one or more of a location name, location number, site location details, lead management contacts, parking information, payment methods, and fee collection methods.

Records may be stored in a memory structure of a database associated with the application server 103. Advantageously, by using records having different classes, the memory structure can pre-allocate a portion of the database to the record in proportion to the number of fields associated with the record. Additionally, in one embodiment records may be stored within a memory structure by class.

In one embodiment, prior to updating an existing record for the site or creating a new record for the site, the processing device may determine whether or not the incoming data is being received from an authorized entity. For example, the memory component of the application server 103 may include a listing of entities (individuals or groups) having varying security permissions. The processing device may first determine whether an entity is permissioned to update the record or provide data for one or more of the fields contained within the record. Information related to a permissioned entity may be stored in a list data structure. In one embodiment, the list data structure of permissioned entities may be linked to the data structure storing the records. For example, a permissioned entity may be labeled a contributor, administrator, and the like. While contributors are permissioned to view, modify, or convert records that they are actively managing, administrators may be permissioned to view, modify, or convert a wider range of records.

Information may be submitted to the application by the entity by one or more methods including, but not limited to, input in a text box, field, selecting icons, selecting checkboxes, radio buttons or icons, voice or text messaging, email, video input. The application may be configured to receive information in a variety of formats, convert the information into a standardized format that is capable of being displayed in the user computing systems. For example, a first person may send an email to an email address associated with the system containing a text description of a site as well as attachments having pictures of the site. A second person may use a webpage or application to enter additional information about the same site in fields provided by the webpage or application. Information from both the first person and the second person may be converted into standardized forms, stored in the record associated with the site, and displayed on the user computing systems. In one embodiment, the record may indicate which entity provided the information associated with a particular field. For example, a record may indicate that Photographs 1-3 were provided by user 1200.

In one embodiment, the processor may be configured to change the class of an existing record. For example, as more information and data is received regarding a “Property” it may be converted into an “Opportunity” which may then be converted into a “Location”. A change in the class of an existing record may reflect that the received data indicates that the site has been developed and met or exceeded pre-determined criteria regarding the development of the site. Pre-established criteria may include meeting deadlines and/or tasks for inspections, site visits, funding, construction, and the like. A processor may be configured to execute code that automatically detects when the pre-established criteria is met or exceeded according to the received data and data stored in the record. Based on the automatic detection, the processor may be configured to execute code that automatically changes or converts the class of the existing record. Alternatively, the processor may detect that the pre-established criteria is met and exceeded and request approval from a user for changing the class of a record. Alternatively, a user may determine that pre-established criteria is met and exceeded and request that the processor execute code to change the class of a record. In yet another alternative, the user may request that the processor execute code to change the class of a record even when the pre-established criteria has not been met or exceeded.

In one embodiment, the processing device may be configured to transmit notification to one or more relevant users of the system and methods described herein when the class of a record has been changed. Relevant users may include all users that contribute information and data to the record, all users that are permissioned to change the class of a record, and the like. Additionally or alternatively, the memory structure may include a list of relevant users that require notification of changes to the class of a record.

In one embodiment, the systems and methods described herein may include one or more secure communication channels for the one or more users of the systems and methods to communicate with each other and/or the host of the application. Secure communication channels may include video chatting, instant messaging, emails, text message, and the like.

The methods and systems of the present disclosure may be carried out as an application running on one or more computing devices (e.g., smart phone, PC), or alternatively within a web browser running one or more computing devices (e.g., PC). In an exemplary embodiment, users of a user computing device may: (1) create leads records for sites which might be suitable for parking locations (referred to herein as a “Property” record), (2) add information to those leads records as the process proceeds towards a purchase of the identified sites (referred to herein as an “Opportunity” record), (3) create new parking location records once and identified site has been acquired (referred to herein as a “Location” record), (4) notify accounting personnel to assimilate the new parking site into the overall parking system and company, and (5) notify transition personnel to ensure the fast and efficient transition of management for the parking site to the overall parking system and company.

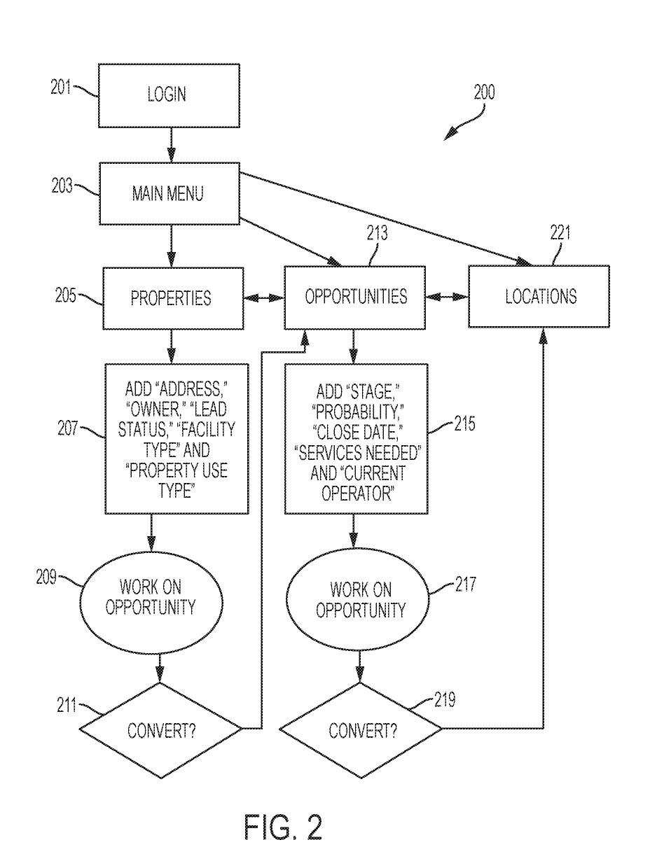

FIG. 2 illustrates a flow diagram 200 depicting a method for managing acquisitions and management of sites. The method may be implemented through software, including one or more program modules resident on the application server 103 and accessed by the one or more user computing devices 111, depicted in FIG. 1. The user computing devices 111 may access the program modules on the application server 103 through a browser program using the Internet or the like.

As illustrated in FIG. 2, a user on a user computing device 111 may have to provide login information 201 in order to access a main menu 203. At the main menu 203, the user may select the record class for which they are providing information for. For example, the user may select that they are providing information for a “Property” 205, an “Opportunity” 213 or a “Location” 221. In some embodiments a new “Property” record may be created including fields such as Address, Owner, Lead Status, Facility Type, and Property Use Type 207. In some embodiments, a new “Opportunity” record may be created including fields such as Stage, Probability, Close Date, Services Needed, and Current Operator 215. Either record may be updated with data and information for the site 209, 217. The data and information for updating the record may be received at the application server 103 from one or more user computing devices 111. A determination may then be made as to whether a “Property” should be converted to an “Opportunity” 211 or an “Opportunity” should be converted to a “Location” 219 in accordance with the systems and methods described above. This determination may be made at the application server 103.

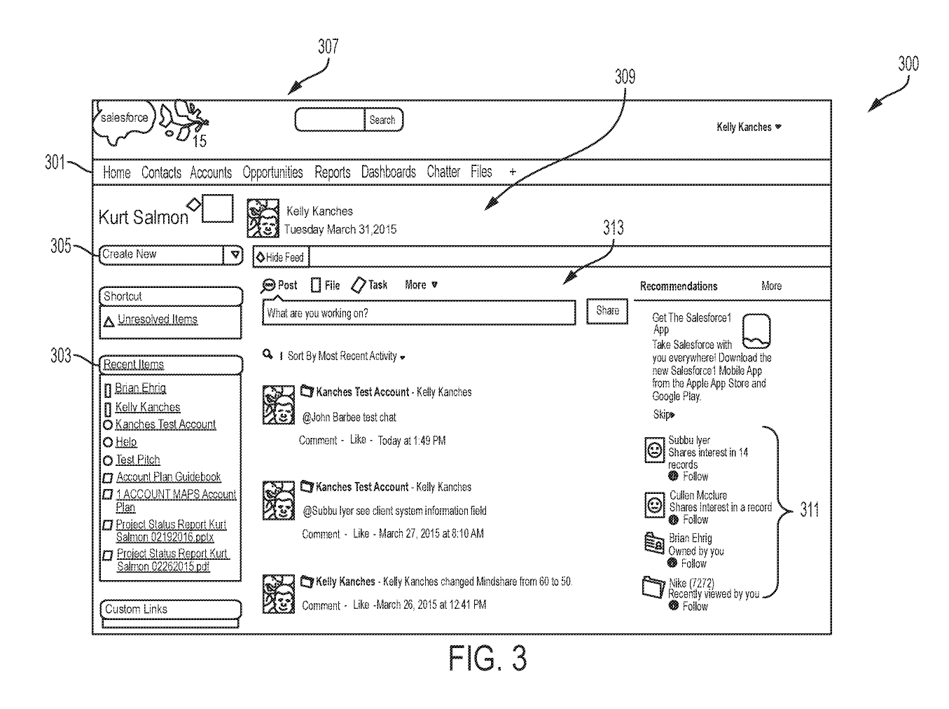

FIGS. 3-30 depict various displays of the user interface of a user computing system 111. In particular the illustrated figures are depicted as being carried out in accordance with an existing software platform (i.e., “salesforce” and “force.com” available from Salesforce.com, Inc., San Francisco, Calif.) that has been programmed and modified. However, those of ordinary skill in the art will realize that the present method may be carried out as a stand-alone computer program, or through various other means and methods. Although the webpages (or portions thereof) illustrated in FIGS. 3-30 may include buttons, click boxes, text boxes, drop down menus and the like, any suitable alternatives such as sliders, radio buttons, tabs, etc. may be used in connection with the depicted webpages.

The user computing systems 111 may initiate a transaction communication with the web server computer 107 via a communication link, such as by initiating an Internet or Intranet browser (e.g., Microsoft Internet Explorer©) on the user computing device 111. Once the communication link is initiated, a security authorization program may be initiated, which operates to permit or deny the user stationed at the user computing device 111. For example, the security authorization program may present the user with a display screen on the visual display 113 of the computing device 111 which includes fields for entering “Username” and “Password” information. Once the user enters pre-assigned “Username” and “Password” information and selects to proceed, the “Username” and “Password” entered may be transmitted to the web server computer 15 for verification purposes.

Upon authorization of the user, a main menu 300 may be displayed on the visual display 113 of the user computer device 111. As illustrated in FIG. 3, an exemplary main menu 300 may include a plurality of display areas, including a Tabs area 301, a Recent Items area 303, a Create New area 305, a Search area 307, a Home Page area 309, a News Feed area 313, and a Recommendations area 311. The specific headings shown in the Tabs area 301 are exemplary only, and any number of headings may be added to this area according to user and/or system specifications. In one embodiment, the headings may correspond to the classes of records available to a user. For example, some specific headings which are used in connection with the present disclosure include “Opportunities,” “Properties,” and “Locations.” Each of these headings will be described in further detail below. “Properties” may include prospects and leads for new parking systems; “Opportunities” may include “Properties” where substantial time or money has been invested on development; “Locations” may be “Opportunities” which have been fully converted to a new parking location capable of accepting customers. Additionally or alternatively the Tabs area 301 may include headings for Contacts, Accounts, Reports, Dashboards, Chatter, Files, Equipment, IT Data, Rate Information, Staffing and the like.

The Recent Items 303 area may display links to recently viewed sites, entities and the like. In some embodiments, these selections may be specific to the user. Selecting the Create New area 305 may cause the system to display a screen in which the user is able to input data and information related to a new site. The Search area 307 may provide a text-field for a user to enter a search query. The Home Page area 309 may include the one or more areas described above. The News Feed area 313 may display information related to sites, users, and other transactions that may be of interest to the user. The user may also be able to post comments, files, tasks, and other data and information publicly (to all other users of the system), or semi-publicly (to select users of the system) using the News Feed 313. The Hope Page may also include a Recommendations area 311 that recommends other users and/or sites that may be of interest to the user.

As discussed above, in one embodiment, the Tabs area 301 of FIG. 3 may include a “Chatter” tab. “Chatter” or any other social media tab may allow users of the system to communicate with each other within the application. The “Chatter” function may be similar to Twitter®. The “Chatter” function may allow a user to follow Users, Contacts, Leads, Opportunities, Locations and Groups. The user may be able to enable/disable email notifications when a new “Chatter” is posted. Additionally, a user may communicate with other members of the platform using the “@” symbol and typing the users name. User settings for “Chatter” may be stored by the application. Information and changes related to “Chatter” may be displayed within the News Feed area 313.

In one embodiment, an email service may be integrated with the application server 103. For example, an email service on a client computer 111 may be synchronized with the client's account on the application server 103. Additional synched factors may include contacts, events, tasks, calendars, and the like.

A “Contact” may be an individual that is related to a “Lead”, “Opportunity”, or “Property”. One or more “Opportunities” may be associated with a “Lead”. Multiple “Opportunities” may be associated with a “Contact” and multiple “Contacts” may be related to a single “Opportunity.” Selecting the “Contacts” tab in Tab area 301 may display information regarding a “Contact”. Such information may include background regarding the Contact Owner, Account Name, Name, Title, Reporting Manager, Phone Number, Email Information, Webpage Information, and the like. In one embodiment, all “Contacts” are linked to “Opportunities.” In such an embodiment, a “Contact” may be created from the webpage displayed when the “Opportunity” page is selected. Alternatively, a “Contact” may be created directly by creating a “Contact” from the “Contact” tab and entering information related to the “Opportunity” into the “Contact” record.

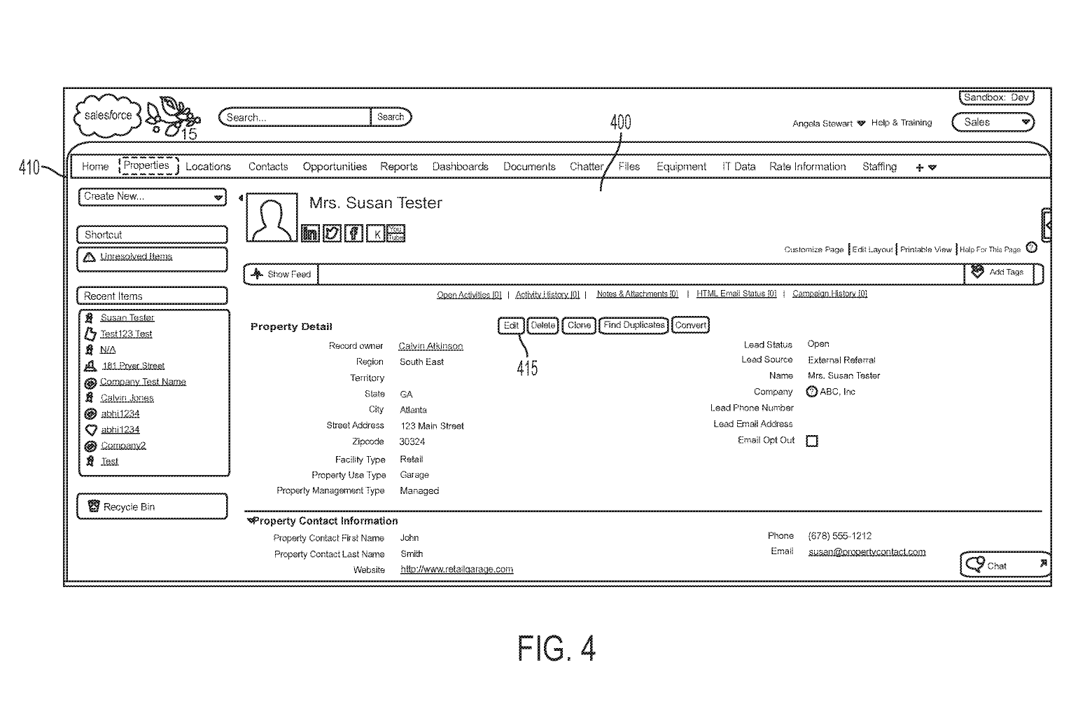

Upon selecting a “Property” from the properties tab illustrated in the Tabs area 201 of FIG. 3, a “Property” record may be displayed as is illustrated in FIG. 4. For example, FIG. 4 shows an exemplary main menu screen 400 including tabs for “Opportunities,” “Properties,” and “Locations” in the Tabs area 410. Also included are tabs for “Contacts,” “Reports,” “Dashboards,” “Documents,” “Chatter,” “Files,” “Equipment,” “IT Data,” “Rate Information,” and “Staffing.” Those of ordinary skill in the art will realize that these tabs are exemplary, and that any number of tabs encompassing differing subject areas may be included on the main menu screen 400. As illustrated the “Property” Record may include details of the specific property including the Record Owner, Region, Territory, State, City, Street Address, Zip Code, Facility Type, Property Use Type, Property Management Type, Lead Status, Lead Source, Name Associated with Lead, Company, Lead Phone Number, Lead Email Address, Email Settings for the Lead, and Property Contact Information. The main menu screen 400 also includes various buttons including an “Edit” button, a “Delete” button, a “Clone” button, a “Find Duplicates” button and a “Convert” button. The “Convert” button is selected to convert a “Property” to an “Opportunity.” As noted above, in one embodiment, a user may convert a “Property” to an “Opportunity” when pre-established criteria has been met or exceeded. For example, the pre-established criteria may be a minimum amount of time and money that has been expended on developing the property. The “Lead Status” of the exemplary property is shown as “Open” indicating that this is a property that is under consideration for purchase.

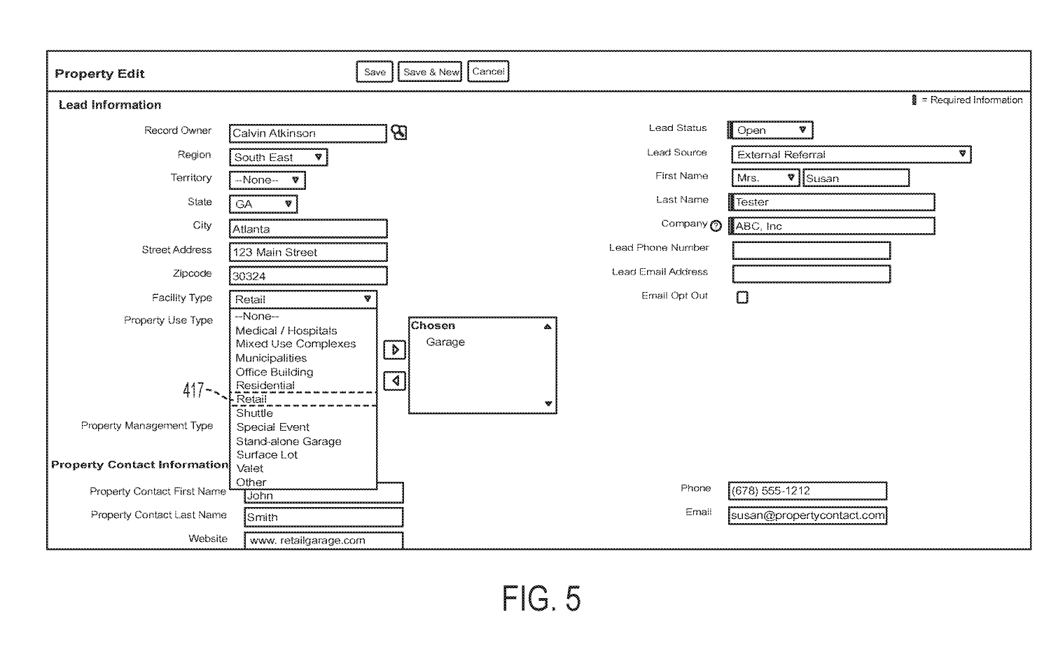

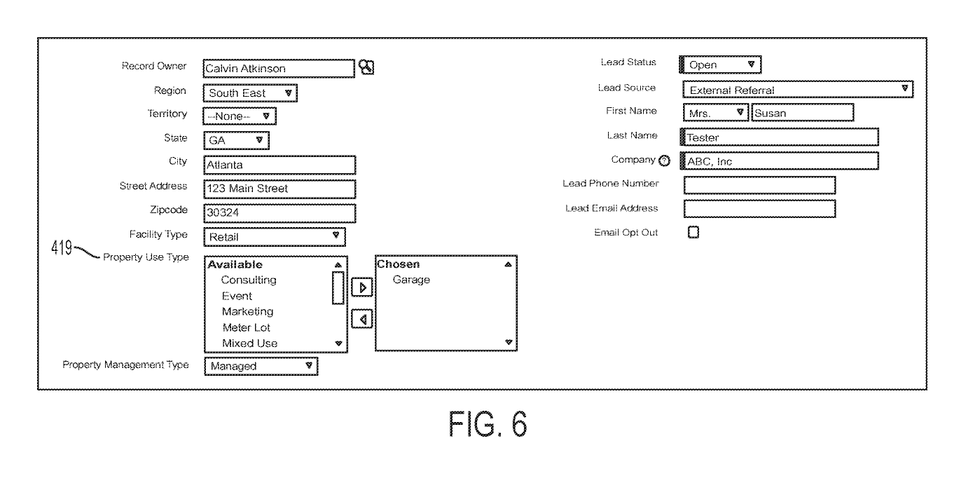

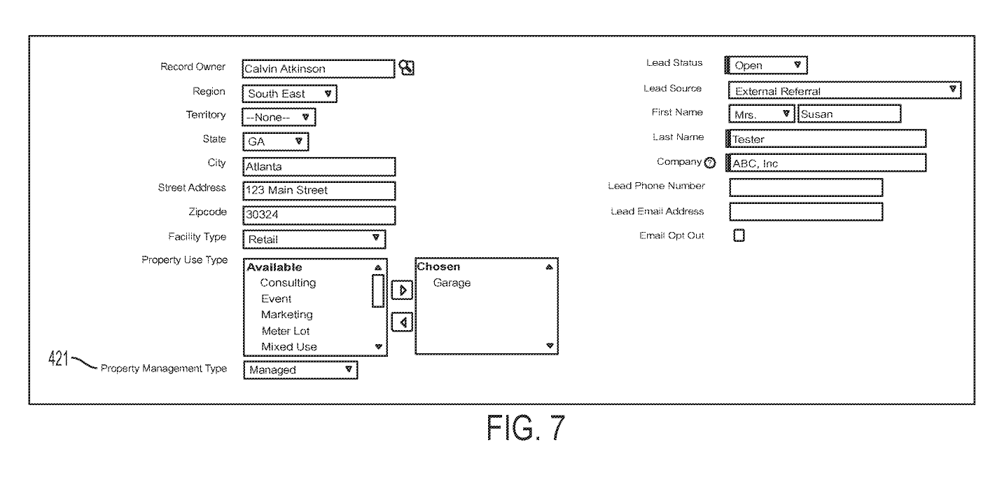

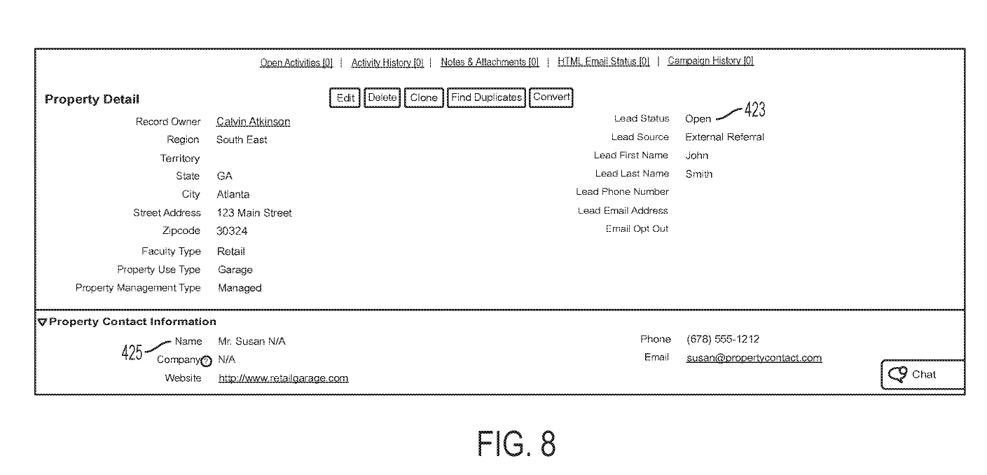

Upon selecting the Edit button in FIG. 4, the main window may be updated to display the property record in an editable format as is depicted in FIGS. 5, 6, and 7. As illustrated in FIG. 5, property information may be updated using textboxes, dropdown menus and the like. For example, as shown in FIG. 5, the “Facility Type” for the Property Record may be changed from “Retail” to various other choices, such as “Residential” and “Office Building” 417. Similarly, as shown in FIG. 6, the “Property Use Type” may also be changed from “Garage” to choices such as like “Meter Lot” or “Mixed Use” 419. As shown in FIG. 7, the “Property Management Type” may also be changed from “Managed” to some other option (e.g., “Leased”) 421. As shown in FIG. 8, lead information 423 and property contact information 425 may also be edited.

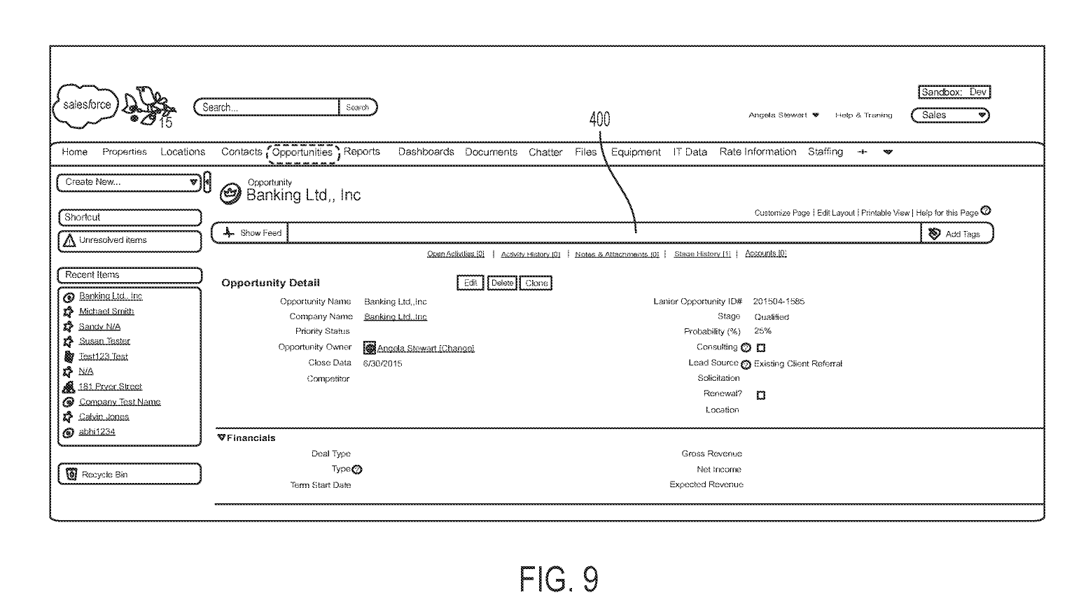

Upon selecting an “Opportunity” from the opportunities tab illustrated in the Tabs area 201 of FIG. 3, an “Opportunity” record may be displayed as is illustrated in FIG. 9. Thus the details of a specific opportunity are shown in the main menu screen 400. In one embodiment, an “Opportunity” may correspond to a prospective sale with a “near term” transaction that a user would like to track. In some embodiments, “near term” may indicate 12 months, however “near term” may be longer for new constructions. As will be discussed below, the “Opportunity” record may store and track information such as the amount, close date, stage, type of deal and win probability of the deal. In one embodiment, an “Opportunity” may follow a naming convention such that the “Opportunity” name provides a quick, meaningful, description of the “Opportunity”.

The main menu screen 400 shows the shows the opportunity name (e.g., Banking Ltd., Inc.) and various other details about the opportunity including the “Company Name”, “Priority Status”, “Opportunity Owner”, “Close Date”, “Competitor”, “Lanier Opportunity ID”, “Stage”, “Probability”, “Consulting”, “Lead Source”, “Solicitation”, “Renewal”, “Location”, and “Financials”. The main menu screen 400 also includes various buttons including an “Edit” button, a “Delete” button, and a “Clone” button. In one embodiment, selecting the “Edit” button will allow a user to edit data and information related to the “Opportunity”, selecting the “Delete” button will remove the “Opportunity” record from the database, and selecting the “Clone” button may create an identical record to the shown “Opportunity” record. As discussed above, “Property” records may be converted to “Opportunity” records when one or more pre-established criteria are met. Accordingly, when a “Property” record is converted to an “Opportunity” record, the “Opportunity” record may retain the property address and contact information of the related “Property” record.

Using the “Opportunities” tab, the user can store and track data and information related to the “Opportunity” such as the amount, close date, stage, type and probability of winning/closing the opportunity, and the like. In addition to the “Opportunity” tab, an “Opportunity” may be accessed by selecting an “Opportunity” listed in the “Recent Items” area, by searching by the “Opportunity Name”, and the like.

An “Opportunity” record has several required fields, including “Stage,” “Probability,” “Close Date,” “Services Needed” and “Current Operator.” In the exemplary main menu screen 400 depicted in FIG. 9, the “Stage” is set to “Qualified,” the “Probability” is set to “25%,” the “Close Date” is set to “6/30/2015,” “the Services Needed” is set to the type of service needed for the location (e.g., “No Service,” “Valet,” etc.), and the “Current Operator” is set to the current operator of the location (e.g., “ABC Parking”).

In one embodiment, the selection of a particular field, may impact other fields in the record. For example, the “Stage” field of an “Opportunity” record may determine the value in other fields of the record. An “Opportunity” record may have various stages including: (1) “Introduction”, (2) “Qualified”, (3) “Proforma Development”, (4) “Proforma Approved”, (5) “Proforma Delivered”, (6) “Post Proforma Follow Up”, (7) “Presentation Development”, (8) “Presentation Approved”, (9) “Presentation Delivered”, (10) “Post Presentation Follow Up”, (11) “Verbal Award/Negotiation”, (12) “Negotiation/Contract Review”, (13) “Location Approval”, (14) “Closed Won”, (15) “Closed Lost”, and (16) “Closed Expired”.

In one embodiment, the “Opportunity” record may have incremental stages. For example, the “Introduction” stage may be the first stage of an “Opportunity”. The “Introduction” stage may correspond to when a site is identified along with the identity of someone involved in the decision-making process for the site. At this stage, a representative may be working towards an introduction of the acquiring company to the contact at the site.

A second stage of an “Opportunity” record may be the “Qualified” stage. At the “Qualified” stage the acquiring company representative may have communicated with a contact at the site and has set up a meeting or next communication.

A third stage of an “Opportunity” record may be the “Proforma Development” stage. The “Proforma Development” stage may correspond to the time between when a contact requests a quote to acquire the site and the time when an authorized representative of the acquiring company officially declares a bid approved. In one embodiment, the authorized representative may be a President or CEO of the acquiring company.

A fourth stage of an “Opportunity” may be the “Proforma Approved” stage. The “Proforma Approved” stage may correspond to the time after an acquiring company has approved a proforma bid, and the time before the approved proforma bid is delivered to the contact at the site by a representative of the acquiring company.

A fifth stage of an “Opportunity” may be the “Proforma Delivered” stage. The “Proforma Delivered” stage may correspond to when a bid has been delivered to a contact associated with the site.

A sixth stage of an “Opportunity” may be the “Post Proforma Follow Up” stage. The “Post Proforma Follow Up” stage may be indicative of active follow up by one or more representatives of the acquiring company with one or more contacts at the site.

A seventh stage of an “Opportunity” may be the “Presentation Development” stage. The “Presentation Development” stage may be indicative of when a contact associated with the site has requested a formal presentation on the bid.

An eighth stage of an “Opportunity” may be the “Presentation Approved” stage. The “Presentation Approved” stage may be indicative of the time between when a presentation has started and when the presentation is approved by an authorized representative of the acquiring company. For example, in one embodiment, the authorized representative may be the Head of the Marketing Department and/or Business Development Department.

A ninth stage of an “Opportunity” may be the “Presentation Delivered” stage. The “Presentation Delivered” stage may be indicative of when an approved presentation has been delivered to the contact at the site.

A tenth stage of an “Opportunity” may be the “Post Presentation Follow Up” stage. The “Post Presentation Follow Up” stage may be indicative of active follow up by the acquiring company with one or more contacts at the site regarding the presentation.

An eleventh stage of an “Opportunity” may be the “Verbal Award/Negotiation” stage. The “Verbal Award/Negotiation” stage may be indicative of when one or more contacts at the site contacts one or more representatives of the acquiring company to notify them of an intention to award the contract for the site to the acquiring company.

A twelfth stage of an “Opportunity” may be the “Negotiation/Contract Review” stage. In the “Negotiation/Contract Review” stage a written contract may be shared between the entities, and the respective representatives may work towards resolving any legal/contractual issues.

A thirteenth stage of an “Opportunity” may be the “Location Approval” stage. The “Location Approval” stage may be reached when both parties of the transaction (the site side and the acquiring company) feel as though the contract will be signed, and identify a specific transition date. The specific transition date may be representative of when a representative of the acquiring company will begin the transition process associated with this new site.

A fourteenth stage of an “Opportunity” may be the “Closed Won” stage. The “Closed Won” stage corresponds to the conversion of the record associated with the site to a “Location” record.

A fifteenth stage of an “Opportunity” may be the “Closed Lost” stage. The “Closed Lost” stage may be indicative of when the life of an “Opportunity” has ended without resulting in a new “Location” (i.e., it did not meet pre-established criteria for converting the “Opportunity” to a “Location” prior to an expiration of time, or other factors).

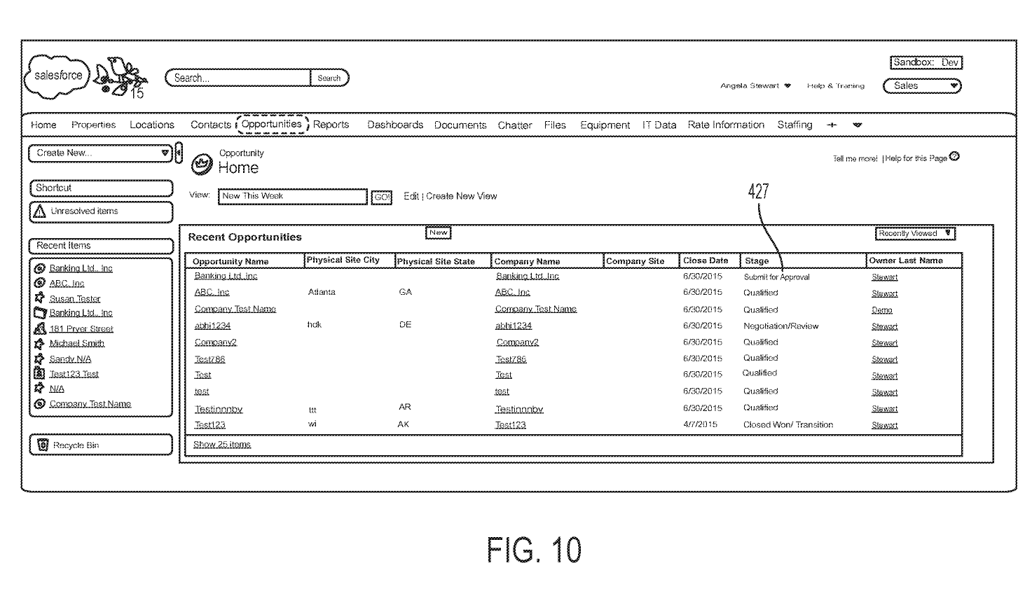

A sixteenth stage of an “Opportunity” may be the “Closed Expired” stage. The “Closed Expired” stage may be indicative of an “Opportunity” record closing because the “Opportunity” has simply passed. As illustrated in FIG. 10, a listing of Opportunities may display Stage Information 427 in the main menu screen 400.

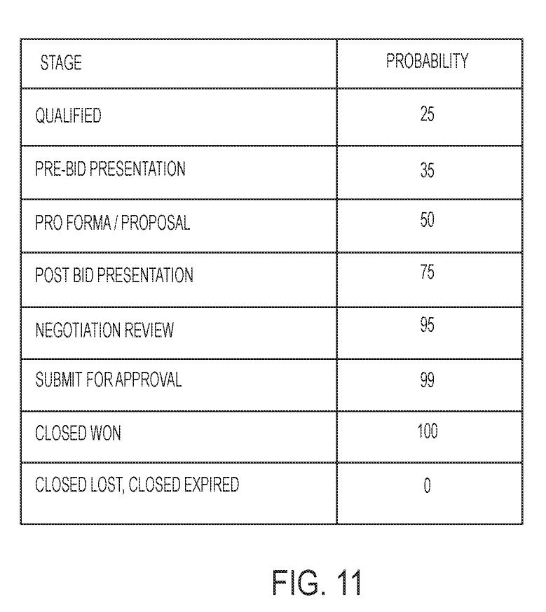

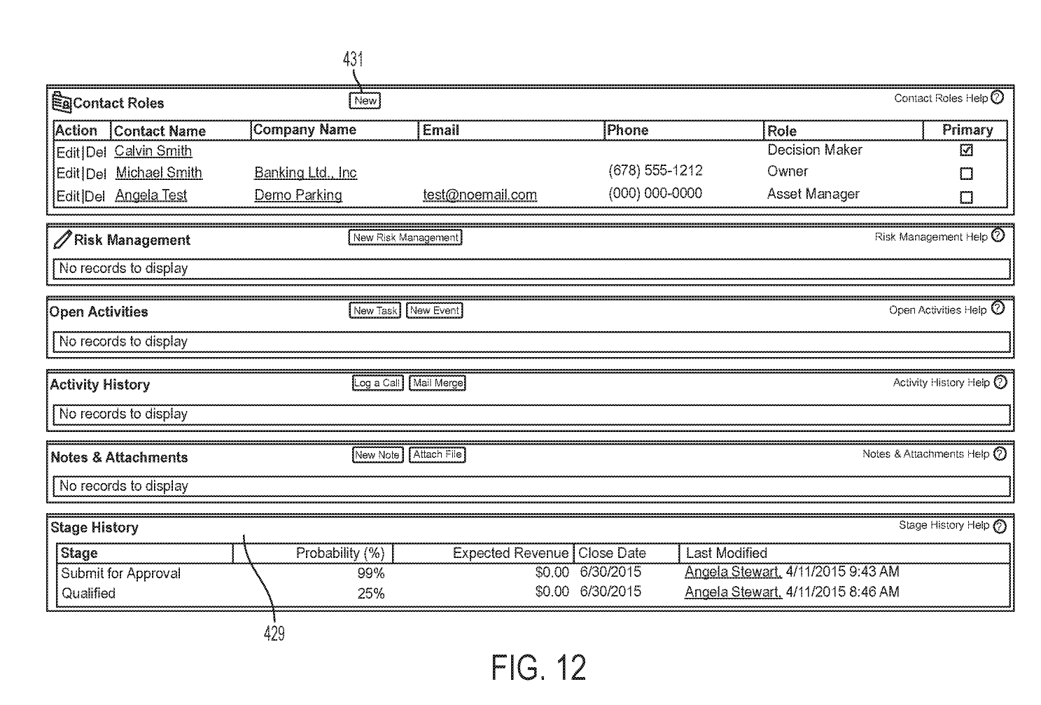

Each stage of an “Opportunity” may be associated with a probability of closure (i.e., probability that the opportunity will be converted to a “Location” and the site will be acquired by the acquiring company). In one embodiment, each of the stages discussed above may be associated with a particular probability. For example, FIG. 11 is a chart showing the probability associated with each stage of the process. As illustrated the “Qualified” stage corresponds to a 25% probability of closure. “Closed Won” corresponds to 100% probability and indicates that an “Opportunity” has been acquired. FIG. 12 illustrates how an Opportunity's stage history 429 may be displayed to a user. FIG. 12 also illustrates various other elements of the “Opportunity” record which may be viewed and modified, including Contact Roles, Risk Management, Open Activities, Activity History, Notes & Attachments, and Stage History (i.e., a history of the stage changes for the Opportunity). New Contacts may be added to the “Opportunity” by selecting the “New” button in the Contact Roles area 431 shown in FIG. 12. A new contact may be a person or organization associated with the site. If the Contact does not already exist, it may be created using the “Contacts” tab in the Tabs area 410 of the main menu screen 400 shown in FIG. 4.

In alternative structure to the sixteen stages associated with an “Opportunity” illustrated in FIG. 10, there may be five selling stages: (1) “Qualify”, (2) “Discover”, (3) “Propose”, (4) “Present”, and (5) “Close”. The “Qualify” Stage may begin when a targeted opportunity and involve activities such as company research, location research, technology research, competitive research, identifying decision makers, identifying networking opportunities and scheduling appointments. The “Qualify” Stage may end once an appointment to being due diligence is scheduled.

After the “Qualify” Stage, the “Opportunity” may enter the “Discover” Stage. The “Discover” Stage may begin once due diligence is scheduled. The “Discover” Stage may entail reviewing research, gathering worksheets, researching the contact and the competitive landscape before the call. It may also include conducting a discovery call to gather pertinent operational and financial data, differentiators, and committing to accept a proposal. After the discovery call, the “Discover” Stage may include beginning a pro-forma. The “Discover” Stage may end once there is a discovery of change priority and decision makers indicate with some level of commitment to proceed.

After the “Discovery” Stage, the “Opportunity” may enter the “Propose” Stage. The “Propose” Stage may begin once a pro-forma is underway, an opportunity is in Salesforce, and submitted to Sales Support for proposal production. Activities during the “Propose” Stage may include receiving proposal and offer components in response to a request for proposal, unsolicited proposals, and lease proposals. Activities may also include developing responses by completing a request for proposal and/or completing a proposal. Additionally, client follow-up including questions about the proposal and presentation requests may be addressed. Once the client proposal is completed and submitted, the “Propose” Stage may end.

After the “Propose” Stage, the “Opportunity” may enter the “Present” Stage. The “Present” Stage may begin with a client invitation extended to present proposals. Pre-presentation questions may involve questions regarding time limits, attendees, internal subject matter experts, differentiators, decision making criteria, delivery format and practice. After the presentation, a thank you email may be sent to the participants. Once the client presentation is completed, the “Present” Stage may end.

After the “Present” Stage, the “Opportunity” may enter the last “Close” Stage. The “Close” Stage may begin with a written or verbal commitment to move forward with a particular solution. The “Close” Stage may include activities such as contract negotiation, win/loss analysis, and determining whether the contract may be won, lost, disqualified, or canceled. Legal teams, subject matter experts, and management may be involved in the “Close” Stage.

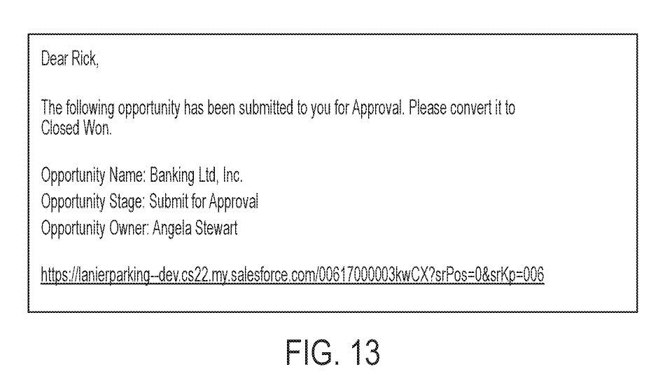

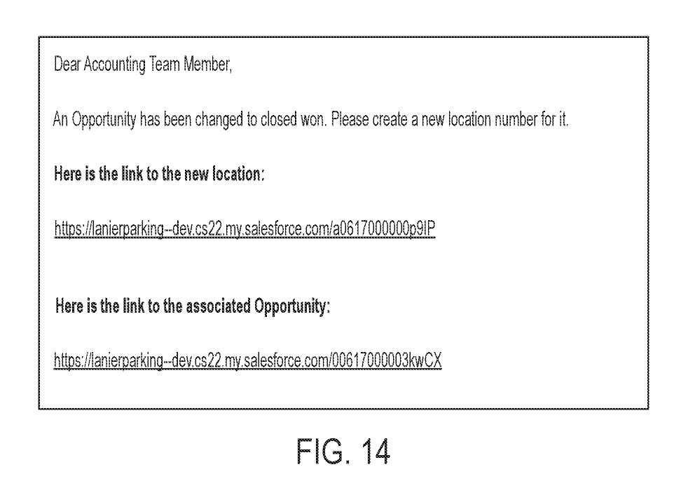

In one embodiment, only authorized users may be permitted to edit and update an “Opportunity” Record to have a “Closed Won” stage. Furthermore, in one embodiment, editing and/or updating an “Opportunity” Record to have a “Closed Won” stage may trigger the application server 103 to provide automatic notifications to one or more departments of the parking entity. For example, the Accounting department may create a “Locations” record based on the information from the “Opportunity,” which sends an email notification about the new “Location” to the Transition Team. For example, when a user change the “Stage” of an “Opportunity” from “Negotiation Review” to “Submit for Approval,” an email may be automatically generated and sent to the person or persons authorized to transition an “Opportunity” to “Closed Won” status. An exemplary email is shown in FIG. 13. When the status change to “Closed Won” is approved by an authorized person, an email may be automatically generated and sent to the Accounting department. The Accounting department may be instructed to create a new “Locations” record. An exemplary email is shown in FIG. 14.

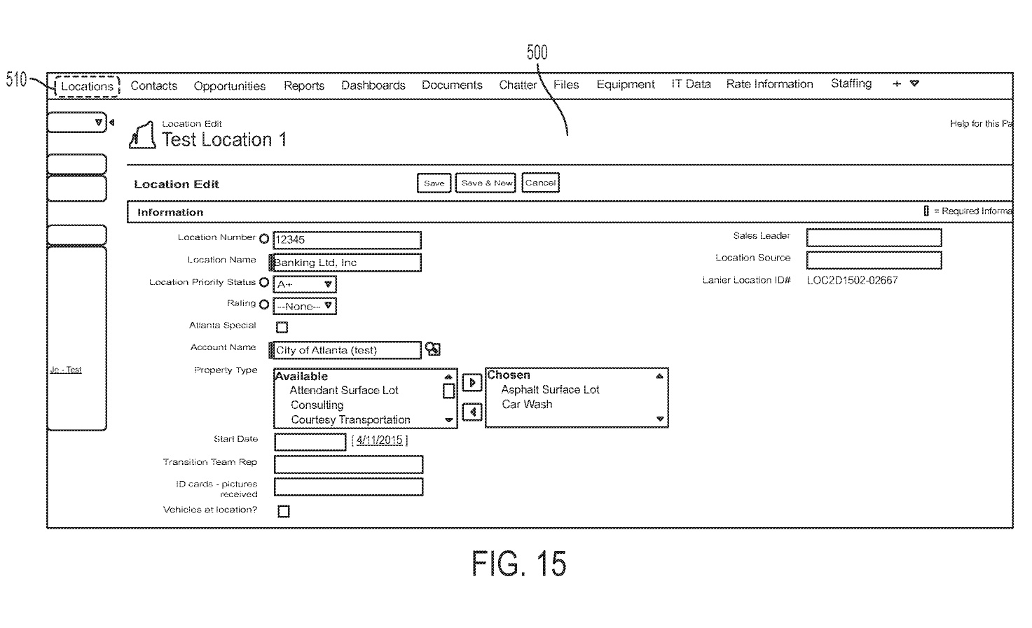

Upon selecting a “Location” from the Locations tab illustrated in the Tabs area 201 of FIG. 3, a “Location” record may be displayed as is illustrated in FIG. 15. For example, FIG. 15 shows an exemplary main menu screen 500 including tabs for “Opportunities,” “Properties,” and “Locations” in the Tabs area 510.

A “Location” record may include one or more fields including, for example, a Location Number, Location Name, Location Priority Status, Rating, Atlanta Special, Account Name, Property Type, Start Date, Transition Team Representative, ID Cards, Vehicles at Location, Sales Leader, Location Source, Location ID, and the like. The main menu screen 500 shows the Location Name (e.g., Test Location 1), a Location Number, and various other details about the “Location.” The Location Number may be created by the Accounting department in response to the automatically generated email discussed above (and shown in FIG. 14). The main menu screen 500 may also include various buttons including a “Save” button, a “Save & New” button, and a “Cancel” button. A user may be configured to edit one or more fields of the “Location” record.

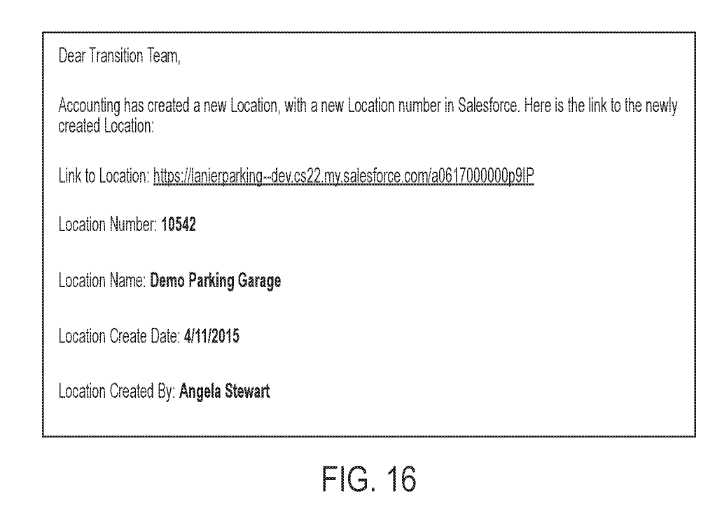

In one embodiment, one or more individuals may receive an email with a link configured to display a “Location” record. For example, when an Accounting department creates a Location Number for a new location, an email may be automatically generated and sent to the Transition department to begin transition management and control of that location from the prior owner. An exemplary email is shown in FIG. 16.

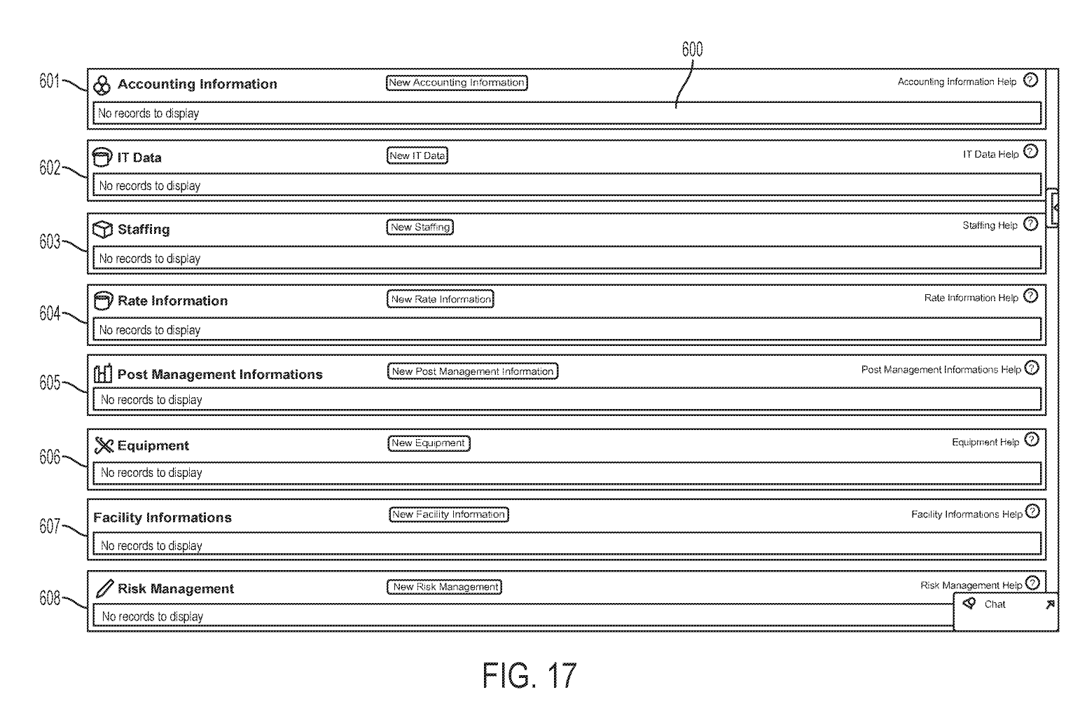

FIG. 17 shows an exemplary location detail screen 600. The location detail screen 600 includes various windows which correspond to details about the location. For example, there may be an Accounting Information window 601, an IT Data window 602, a Staffing window 603, a Rate Information window 604, a Post Management Information window 605, an Equipment window 606, a Facility Information window 607, and a Risk Management window 608. Those of ordinary skill in the art will realize that other types of windows may be presented on the location detail screen 600, depending upon the type of location, requirements, etc. Each window on the location detail screen 600 preferably includes an ‘edit’ button for either adding new information, or editing the existing information. For example, a user may select the ‘edit’ button for the IT Data window 602 and enter information on the types of IT equipment that will be needed for the location (e.g., five Personal Computers (PCs), 2 tablet computers, etc.). As an alternative to the location detail screen 600, the main menu screen 400 may include tabs which provide direct links to location details such as “IT Data,” “Rate Information” and the like (see FIG. 4).

In one embodiment, the main menu screen 400 includes a claim tab configured to allow the submission and processing of customer “claims” against the site or location. For example a “Claim” may include information regarding how a customer's car was damaged during parking.

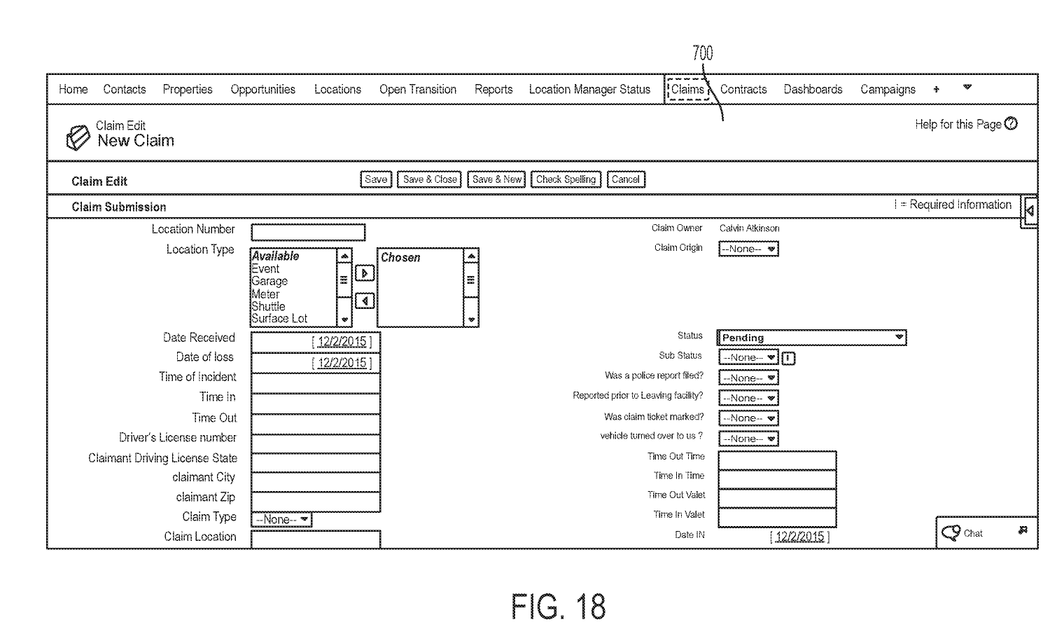

Upon a user selecting the “Claims” tab, a claim main menu screen 700 may be displayed as is illustrated in FIG. 18. The claim main menu screen 700 may display details of a specific claim including the Location Number, Location Type, Date Received, Date of Loss, Time of Incident, Time In, Time Out, Driver's License Number, Claimant Driving License State, Claimant City, Claimant Zip, Claim Type, Claim Location, Claim Owner, Claim Origin, Status, Sub-Status, Police Report Activity, Claim Ticket Marking, Time Out Time, Time In Time, Time Out Valet, Time In Valet, Date In and the like. The claim main menu screen 700 may also include various buttons such as Save, Save and Close, Save and New, Check Spelling, Cancel and the like.

“Claims” may be entered into the system of the present invention through a mobile computing device (e.g., tablet computer, smartphone) which is carried by an operator at the location (e.g., parking attendant) and connected wirelessly to the Internet. Alternatively, “claims” can be entered locally at a computing device (e.g., PC, smartphone, tablet) which has a wired or wireless connection to the Internet, and which may be resident in a main office for the location, or entered by a user at the site. The system of the present invention may use location-based data (e.g., GPS, WiFi, etc.) to partially populate the claim fields with data on the closest location.

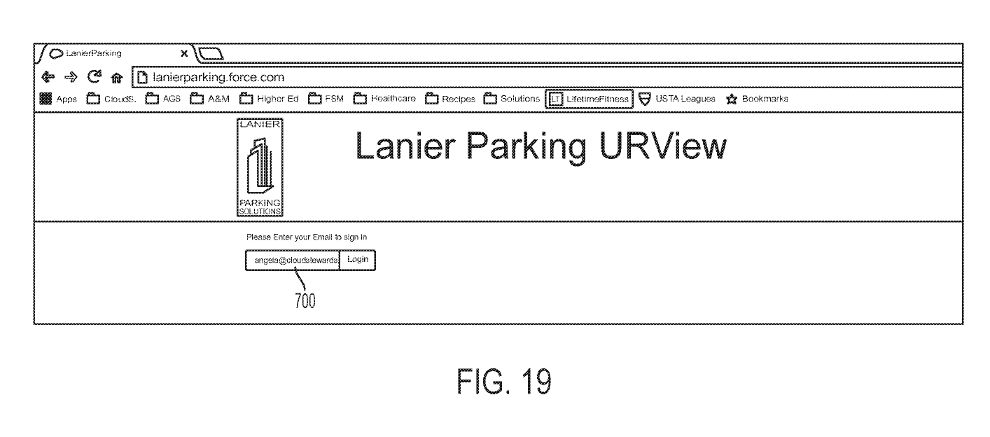

FIGS. 19-28 show exemplary screens which are displayed in a claim entry process. As a first step, the user enters a Uniform Resource Locator (URL) for a server location where an Application Programming Interface (API) may be accessed (e.g., lanierparking.force.com), and is presented with a login screen 700, as shown in FIG. 19. At the login screen 700, the user enters their email address to gain access. Since email addresses will only be given to authorized employees of the location, the system may not also require a password, but in some cases a password may be required. Alternatively, a username, or other information that can be verified against a list of authorized users may be used.

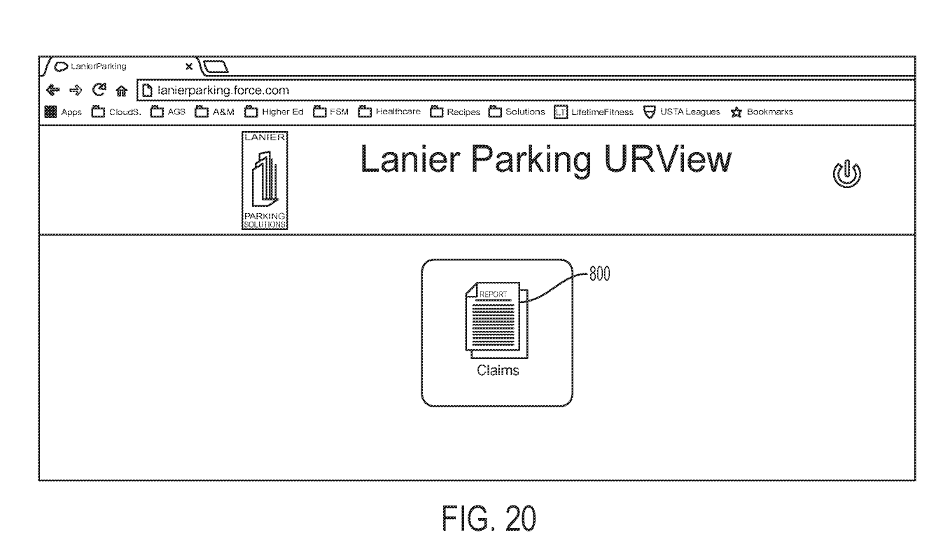

Once granted access, the user is presented with one or more software applications they have authorized access to as is illustrated in FIG. 20. The Claims software application 800 may be selected by the user.

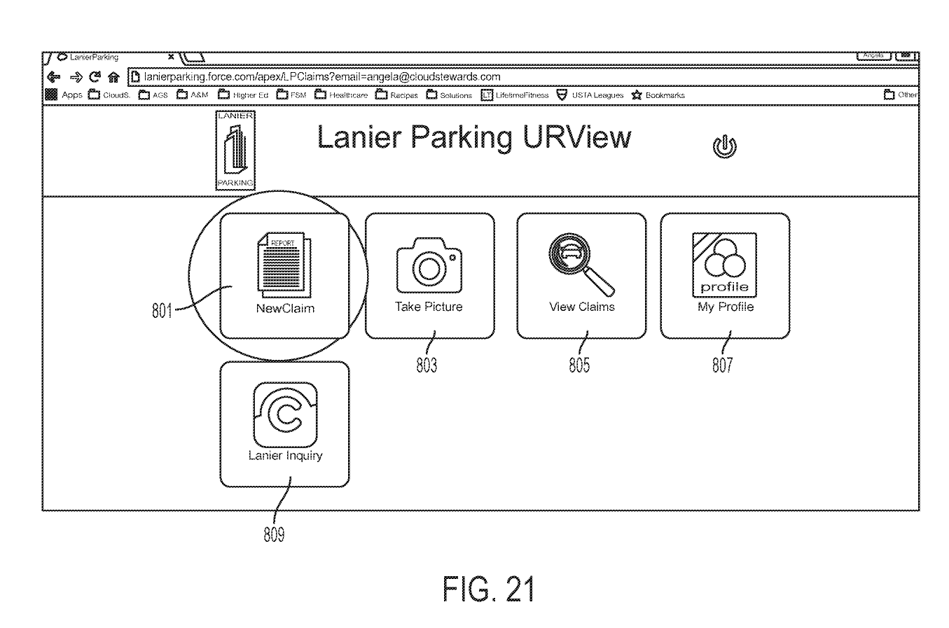

Selecting the Claims software application 800 in FIG. 20 may display the menu illustrated in FIG. 21. The user may be presented with various selectable buttons including a “New Claim” button 801, a “Take Picture” button 803, a “View Claims” button 805, a “My Profile” button 807 and an “Inquiry” button 809, and the like. If the user selects the “New Claim” button 801, the process of entering new claim will be initiated.

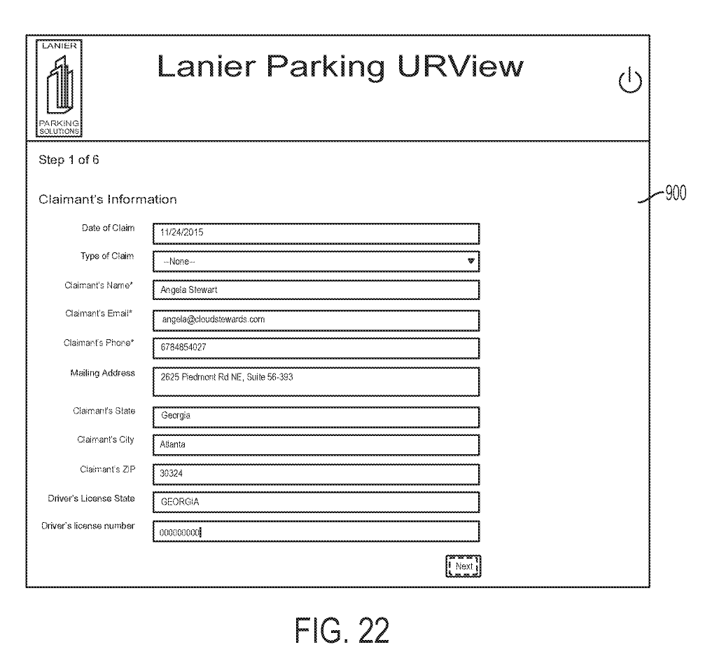

As will be illustrated in FIGS. 22-28, the process of entering a new claim may involve multiple steps. For example, as illustrated in FIG. 22, in a first step, a claimant information screen 900 may be displayed. The claimant information screen 900 may include fields for inputting information related to the claim. Fields may include “Date of Claim”, “Type of Claim”, “Claimant's name”, “Claimant's Email”, “Claimant's Phone”, “Mailing Address”, “Claimant's State”, “Claimant's City”, “Claimant's ZIP”, “Driver's License State”, “Driver's License Number” and the like.

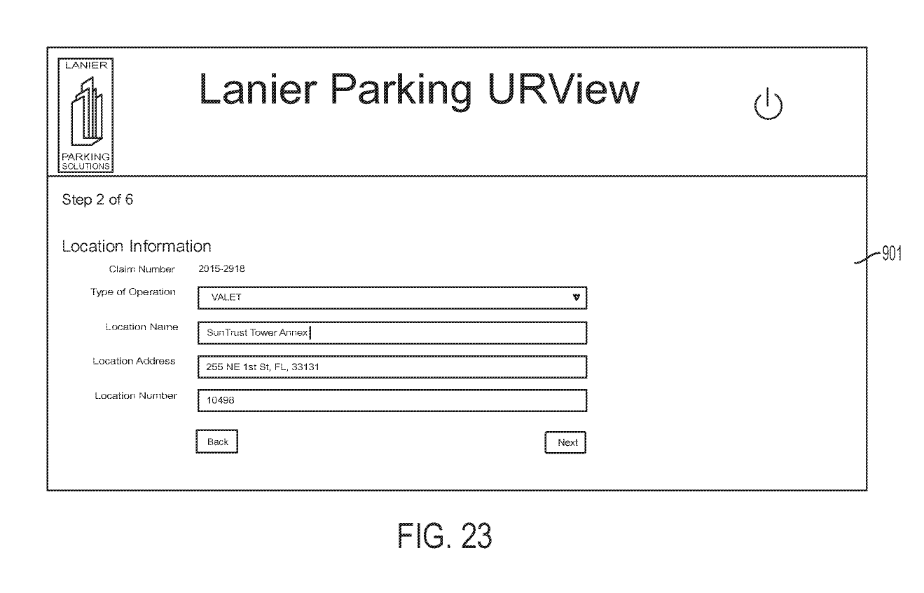

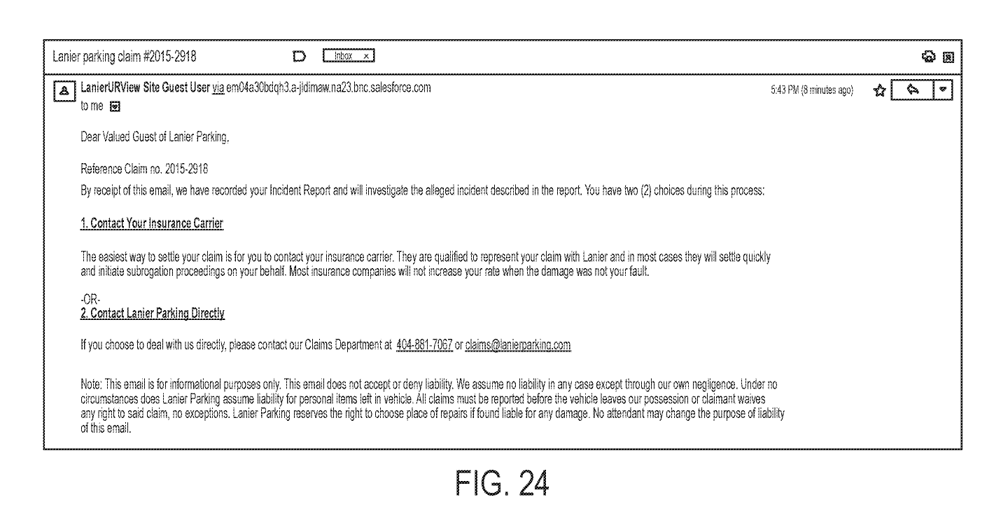

Once all the required information has been entered, the user may select the “Next” button to move to the claim location screen 901 shown in FIG. 23. The claim location screen 901 may include one or more fields including, for example, “Claim Number”, “Type of Operation”, “Location name”, “Location Address”, “Location Number” and the like. One or more of the fields may be automatically populated based on the claimant's information entered on the claimant information screen 900. The claim location screen 901 may also specify a “Claim Number” which is generated by the system and provides a specific reference for the claim. In one embodiment, once the information is entered on the claim location screen 901 and the user selects the “Next” button, an email may be sent to the claimant. An exemplary form of such an email is shown in FIG. 24. The email may notify the claimant of receipt of their claim, provide instructions for contacting the claimant's insurance carrier, provide instructions for contacting the parking site manager, and the like.

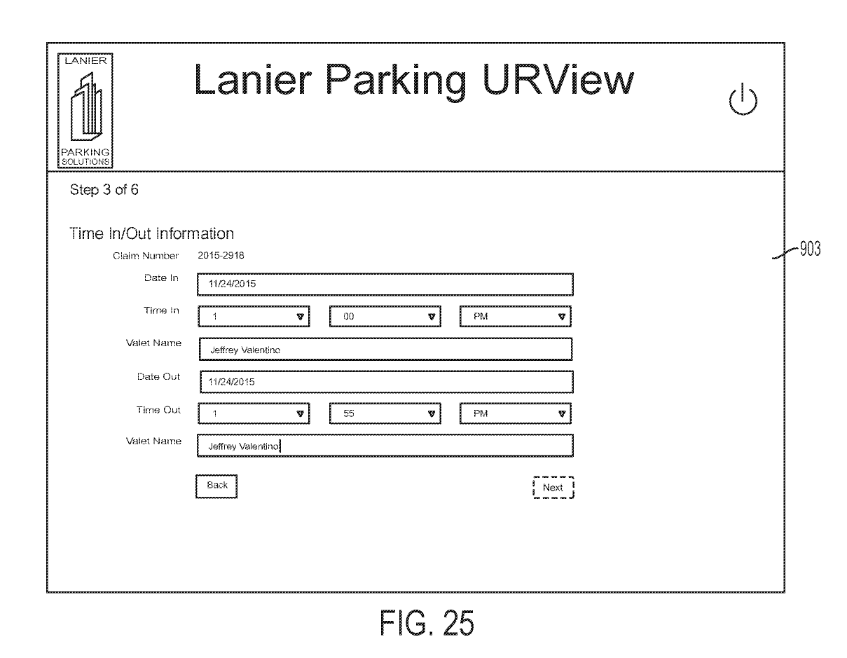

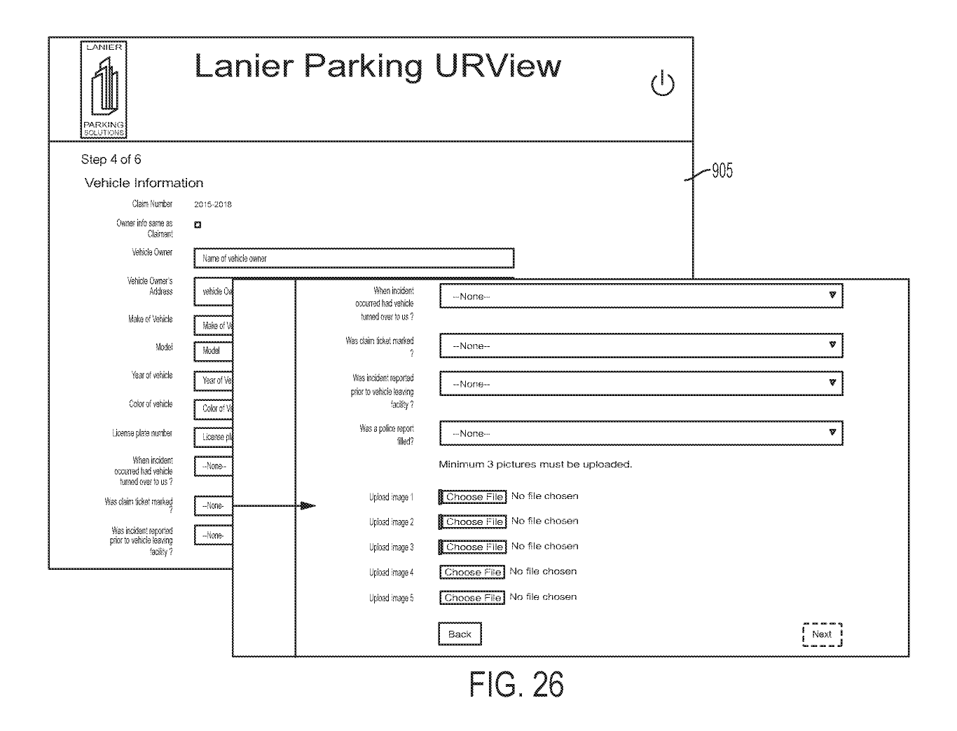

In one embodiment, once the information is entered on the claim location screen 901 and the user selects the “Next” button, the time entry screen 903 shown in FIG. 25 may be displayed. The user may enter the “Time In/Out” information for the claimant on a time entry screen 903. The time entry screen 903 may include fields for details which may be relevant to the claim, such as “Claim Number”, “Date In”, “Date Out”, “Valet Name,” “Time In” and “Time Out.” After the relevant information is entered, the user selects the “Next” button and is brought to the claimant property screen 905, as shown in FIG. 26.

In the exemplary claimant property screen 905 shown in FIG. 26 the property is an automobile, but those of ordinary skill in the art will realize that the claimant's property could be various things based on the location and the function of the location. The claimant property screen 905 may require a minimum number of photographs/images of the claimant's property (e.g., 3) in order to proceed with claim, as noted in FIG. 26. Alternatively, there may be no minimum number of photographs/images of the claimant's property required. In the case of an automobile claim, the claimant property screen 905 may include fields for “Claim Number”, “Owner Info same as Claimant”, “Vehicle Owner”, “Vehicle Owner's Address”, “Make of Vehicle”, “Model”, “Year of Vehicle”, “Color of Vehicle”, “License Plate Number”, “When Incident Occurred”, and the like.

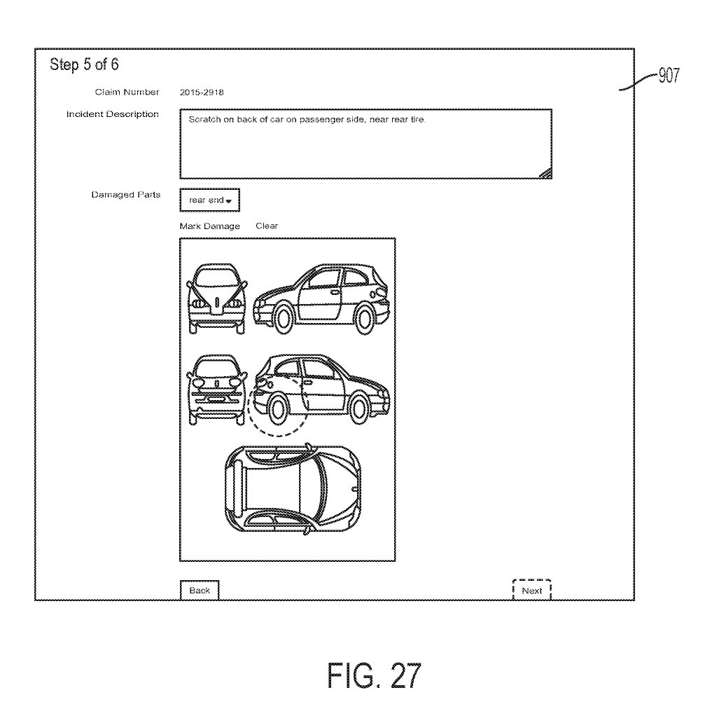

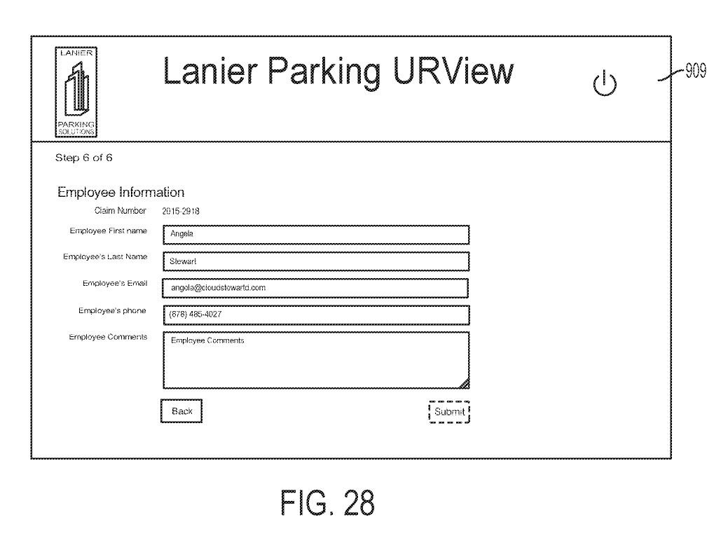

Once the user enters the information and selects the “Next” button, the user is taken to an incident description screen 907, as shown in FIG. 27. The incident description screen 907 may include an open field for providing a detailed description of the incident, and a property damage field which may specifically describe the property damage. In the exemplary incident description screen 907 shown in FIG. 27, the property damage filed includes images of an automobile which the user may annotate by selecting a “Mark Damage” button. The user may draw free form lines to shown the damage, and/or mark areas with an “X” by selecting them with a cursor; any mistakes may be corrected by selecting the “Clear” button and starting over. Once the user enters the required information and selects the “Next” button they are taken to an employee information screen 909, as shown in FIG. 28. The employee information screen 909 may include fields for the user (location employee) to enter their name, email, phone, and comments on the incident. Once the user (location employee) enters the information and selects the “Submit” button they are guided back to the “Claims” software application screen shown in FIG. 20, from which they can start another claim, view claims, etc.

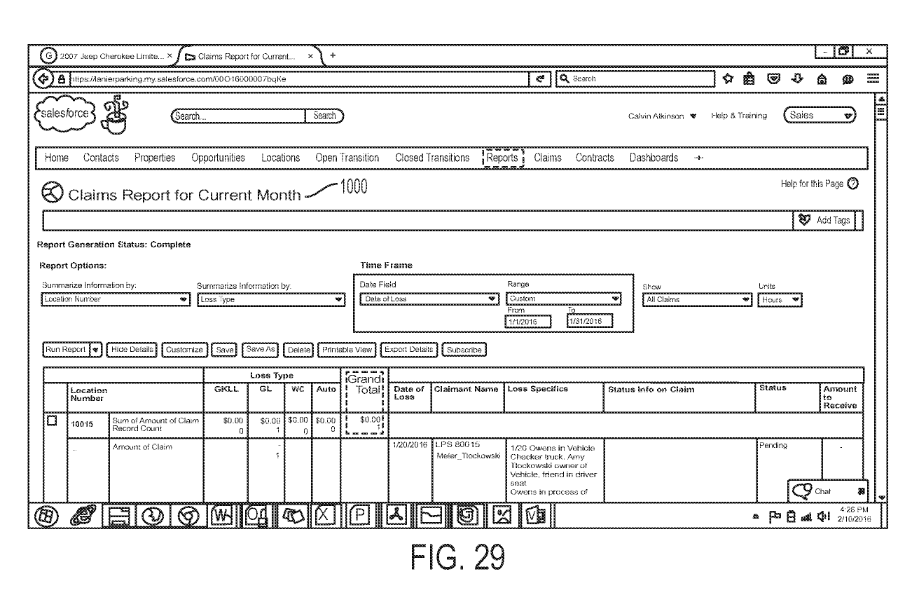

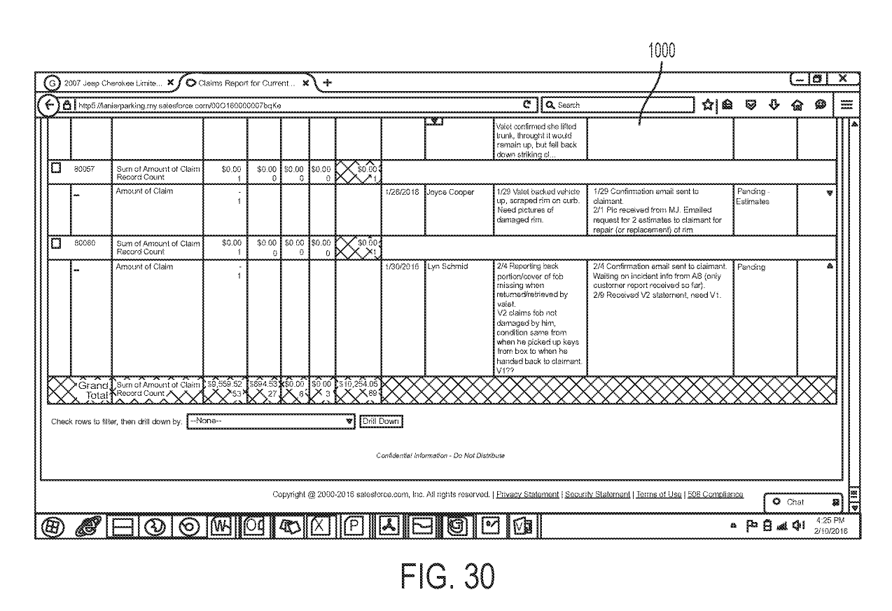

FIGS. 29 and 30 show first and second portions, respectively, of a claims report screen 1000. The claims report screen 1000 may be accessed by selecting the “Reports” tab on the exemplary main menu screen 400 of FIG. 4. The claims report screen 1001 may include fields for the specifying the time frame for the claims, and organizing such claims by “Location Number,” “Loss Type,” etc. The claims report screen 1001 also includes various buttons including a “Run Report” button, a “Save” button, a “Delete” button, and an “Export Details” button (for exporting the details of a specific claim or claims to another computer-readable format, such as an Microsoft Excel file). In the exemplary claims report screen 1001, the claims are identified by “Location Number” along a left-hand column of a table, with the rest of the table including important date regarding each claim (e.g., Date of Loss, Claimant Name, Status). This information is particular useful in tracking claims resolutions, so that claims do not get lost or remain pending for too long a period of time.

Although the invention has been described in terms of exemplary embodiments, it is not limited thereto. Rather, the appended claims should be construed broadly to include other variants and embodiments of the invention which may be made by those skilled in the art without departing from the scope and range of equivalents of the invention. This disclosure is intended to cover any adaptations or variations of the embodiments discussed herein.

1. A system for managing the acquisition and management of sites, the system comprising:
a database stored on a server;
an exchange application associated with an acquisition and management service and installed on one or more user devices accessible to one or more users, wherein each of the one or more user devices includes a user interface; and
a processing device of the server, wherein the processing device is in communication with the user interfaces and executes the exchange application, the processing device configured to:
receive, from at least one of the one or more user devices, data associated with a site;
determine whether the database contains a record associated with the received site;
create, in the database, a new record for the site when it is determined that the database does not contain the record associated with the site;
update, in the database, an existing record for the site when it is determined that the database contains the record associated with the site; and
cause the user interface on the one or more user devices to display updated information retrieved from the database.

2. The system of claim 1, wherein the one or more user devices each comprise at least one of tablet computers, smart phones, personal digital assistants, and personal computers.

3. The system of claim 1, wherein the processing device is further configured to determine whether the received data is from an authorized individual prior to the processing device at least one of creating a new record and updating the existing record for the location.

4. The system of claim 1, wherein a record is associated with a class, said class being one of a property, an opportunity and a location.

5. The system of claim 4, wherein a record associated with a property includes information regarding one or more of a property address, and an owner.

6. The system of claim 4, wherein a record associated with an opportunity includes information regarding one or more of a stage, a probability, a close date, services needed, and a current operator.

7. The system of claim 4, wherein a record associated with a location includes information regarding one or more of a location name, location number, site location details, lead management contacts, parking information, payment methods, and fee collection methods.

8. The system of claim 4, wherein the processor is further configured to change the class the existing record is associated with when updating the existing record.

9. The system of claim 8, wherein the processor changes the class the existing record is associated with responsive to, at least one of the received data associated with the site and the data contained within the existing record, meeting or exceeding one or more pre-established criteria.

10. The system of claim 1, wherein the processing device is further configured to transmit a notification to one or more relevant users of the system of a change in record class.

11. The system of claim 1, further comprising one or more secure communication channels for the one or more users to communicate.

12. A method for managing the acquisition and management of sites, the method comprising:
receiving, at an exchange application associated with an acquisition and management service, data associated with a site from one or more user devices,
wherein the exchange application is installed on the one or more user devices accessible to one or more users and executed by a processing device of a server, the processing device in communication with the user interfaces and a database of the server;
determining, by the processing device, whether the database contains a record associated with the received site;
creating, by the processing device, a new record for the site in the database when it is determined that the database does not contain the record associated with the site;
updating, by the processing device, an existing record for the site in the database when it is determined that the database contains the record associated with the site; and
causing, by the processing device, the user interface on the one or more user devices to display updated information retrieved from the database.

13. The method of claim 12, wherein the one or more user devices each comprise at least one of tablet computers, smart phones, personal digital assistants, and personal computers.

14. The method of claim 12, further comprising determining, by the processing device, whether the received data is from an authorized individual prior to the processing device at least one of creating a new record and updating the existing record for the location.

15. The method of claim 12, wherein a record is associated with a class, said class being one of a property, an opportunity and a location.

16. The method of claim 15, wherein a record associated with a property includes information regarding one or more of a property address, and an owner.

17. The method of claim 15, wherein a record associated with an opportunity includes information regarding one or more of a stage, a probability, a close date, services needed, and a current operator.

18. The method of claim 15, wherein a record associated with a location includes information regarding one or more of a location name, location number, site location details, lead management contacts, parking information, payment methods, and fee collection methods.

19. The method of claim 15, further comprising changing, by the processing device, the class the existing record is associated with when updating the existing record.

20. The method of claim 19, wherein changing the class the existing record is associated with is responsive to at least one of the received data associated with the site and the data contained within the existing record, meeting or exceeding one or more pre-established criteria.

21. The method of claim 11, further comprising transmitting a notification to one or more relevant users of the acquisition and management service of a change in record class.

22. The method of claim 11, further comprising communicating, via a secure communications channel, with one or more relevant users of the acquisition and management service.
